(19) United States
(12) Patent Application Publication
(10) Pub. No.: US 2025/0271119 A1
(43) Pub. Date: Aug. 28, 2025

(54) ILLUMINATION APPARATUS

(71) Applicant: ams International AG, Jona (CH)

(72) Inventor: Nicolino STASIO, Zurich (CH)

(21) Appl. No.: 18/859,170

(22) PCT Filed: Apr. 24, 2023
(86) PCT No.: PCT/EP2023/060600

§ 371 Date: Oct. 23, 2024

(30) Foreign Application Priority Data
Apr. 26, 2022 (GB) 2206055.2

(51) Int. Cl. F21V 9/14; F21V 5/00; F21Y 115/30

(52) U.S. Cl. CPC F21V 9/14; F21V 5/007; F21Y 2115/30

(57) ABSTRACT

Disclosed herein is an illumination apparatus and a method of manufacturing the same. The illumination apparatus comprises an array of optical elements, and at least one radiation-emitting element configured to generate, in cooperation with the array, a structured light pattern. An optical phase-retardation of each optical element of radiation emitted by the at least one radiation-emitting element is configured such that the structured light pattern comprises a regular array of dots.

### FIELD OF INVENTION

The present disclosure relates to the field of illumination apparatuses for use in depth mapping applications, and relates in particular to an illumination apparatus for generating structured light patterns, such as dot patterns.

### BACKGROUND

Depth mapping of a scene, also known as 3-dimensional (3D) mapping, is commonly employed by electronic devices, for example smartphones, tablet devices, games consoles and laptop computers.

In some examples, depth mapping of a scene may be used for security purposes, such as to enable access to a resource on an electronic device or unlock the electronic device based on 3D facial recognition. In some examples, electronic devices may also comprise image-sensing devices such as cameras, wherein a depth-map of a scene may be used to improve image-capturing capabilities of the image-sensing devices.

Several techniques for depth mapping are known. For example, stereo-vision cameras may be employed to determine a depth map of a scene based upon disparities between images captured by a plurality of cameras. Some depth mapping techniques may include illumination of a scene, wherein characteristics of the illumination may be used to determine a depth-map of the scene.

In some examples, structured light, e.g. a light pattern, may be used. Therein, structured light may be projected onto a scene and a pattern created in the scene by the projected structured light makes it possible to distinguish features of the scene according to their distance from the structured light-emitting apparatus. That is, an image of the structured light as projected onto a scene may be compared to a reference pattern, and disparities between the image and the reference pattern may be used to determine a depth map of the scene.

It is known that, for an illumination apparatus comprising an microlens array (MLA) comprising microlenses regularly arranged with a microlens pitch “d”, and a plurality of radiation-emitting elements arranged on a common plane at a distance “dᵥₘ” from the MLA, wherein each radiation-emitting element is configured to emit radiation having wavelength “A”, a particularly high contrast structured light pattern may be achieved when:

$${d}_{VM} = N \frac{{d}^{2}}{2 λ} \qquad Equation ( 1 )$$

and where N is a positive integer.

The particularly high contrast structured light pattern may be a regular dot pattern having dots arranged with a defined pitch and an associated defined size. However, to achieve such a high contrast structured light pattern, the relationship between λ, d, dᵥₘ and N defined by Equation 1 must be met, thereby imposing physical limitations on a design of such an illumination apparatus.

Furthermore, a relationship between the pitch and the size of the dots in the generated regular dot pattern is fixed, wherein a particular selection of integer N may be used to select a pitch and hence also an associated size of the dots. As such, an illumination apparatus for generating a regular dot pattern and designed with feature dimensions adhering to Equation 1 exhibits a fixed relationship between dot sizes and dot pitch. Such a fixed relationship between dot size and dot pitch may limit degrees of freedom in the selection of the regular dot pattern.

It is therefore desirable to provide an illumination apparatus that is suitable for generating structured light patterns suitable for use in depth mapping applications, wherein the illumination apparatus is capable of generating a high contrast pattern without being limited to meeting the requirements of Equation 1.

Furthermore, it is desirable that a pitch and dot size of a dot-pattern generated by such an illumination apparatus is not limited by a particular relationship between the pitch and dot size.

Furthermore, it is also desirable that such an illumination apparatus is suitable for use in electronic devices such as smartphones, smart-watches, tablet devices, games consoles and laptop computers, wherein the illumination apparatus does not substantially increase a cost, complexity and/or size of the electronic device.

It is therefore an aim of at least one embodiment of at least one aspect of the present disclosure to obviate or at least mitigate at least one of the above identified shortcomings of the prior art.

### SUMMARY

The present disclosure relates to the field of illumination apparatuses for use in depth mapping applications, and methods of manufacturing such, illumination apparatuses. The present disclosure relates in particular to an illumination apparatus for generating structured light patterns, such as dot patterns.

According to a first aspect of the disclosure, there is provided an illumination apparatus comprising: an array of optical elements; and at least one radiation-emitting element configured to generate, in cooperation with the array, a structured light pattern. An optical phase-retardation of each optical element of radiation emitted by the at least one radiation-emitting element is configured such that the structured light pattern comprises a regular array of dots.

Advantageously, by configuring the optical phase-retardation of each optical element, a high-contrast dot pattern may be generated wherein dimensions of the illumination apparatus do not adhere to meeting the requirements of Equation 1. That is, by configuring the optical phase-retardation of each optical element, e.g. each individual optical element or subset of optical elements, a relatively high-contrast dot pattern may be generated, wherein a distance ‘D’ between the at least one radiation-emitting element and the array of optical elements is not defined by Equation 1. Furthermore, a pitch and a dot size of the pattern are not defined by a relationship that occurs when the distance ‘D’ is defined by equation 1, e.g. a high contrast or ‘HC plane’, as described in more detail below.

The array of optical elements may comprise a plurality of optical elements having a different optical phase-retardation to one another.

That is, each optical element or subset of optical elements may be configured to exhibit different optical phase-retardation characteristics, such that the array of optical elements comprises optical elements having differing optical phase-retardation characteristics. That is, in embodiments the array of optical elements is not an array of optical elements all configured to exhibit the same optical phase-retardation characteristics.

Each optical element may comprise a microlens.

As such, the array of optical elements may be a microlens array (MLA).

The optical phase-retardation each microlens may be defined, at least in part, by a thickness of a base portion each microlens.

Advantageously, a microlens array may be fabricated wherein different microlenses of the array exhibit different optical phase-retardation characteristics based on the thickness of the base portion each microlens. Beneficially, no additional components or materials are required to implement such a microlens array, relative to a prior art microlens array having a uniform distribution of identical microlenes.

The optical phase-retardation each microlens may be defined, at least in part, by a refractive index of each microlens.

Each microlens may be formed from a material having a refractive index selected to provide a desired optical phase-retardation.

The optical phase-retardation each microlens may be defined, at least in part, by a refractive index of a portion of a substrate upon which each microlens is provided.

The optical phase-retardation each microlens may be defined, at least in part, by features such as materials, shapes and dimensions, that may be selected to add a desired, localized phase retardation.

For example, a substrate may be pattered with materials having different refractive indices, and an MLA may be formed over the pattern, thereby providing an MLA wherein different lenses exhibit different optical phase-retardation characteristics.

Each optical element may comprise a metalens.

The optical phase-retardation of each metalens may be defined by dimensions of one or more pillars forming each metalens.

The optical phase-retardation of each metalens may be defined by a relative rotation and/or shape of one or more mesas or fin-like structures forming each metalens.

Advantageously, no additional materials, such as materials having different refractive indices, are required to implement lenses having different optical phase-retardation characteristics.

The array may be disposed at a first distance (d_{VM1}) from the at least one radiation-emitting element and wherein the optical phase-retardation of each optical element may be configured such that the structured light pattern comprises a regular array of dots having a pitch and/or dot size that would be provided by a further illumination apparatus comprising: a further array of identical optical elements arranged with a same pitch (d) as the array of optical elements; the further array of identical optical elements at a second distance (dᵥₘ₂) from a further at least one radiation-emitting element configured to emit radiation with a same wavelength (λ) as radiation from the at least one radiation-emitting element, wherein the second distance (dᵥₘ₂) is different from the first distance (dᵥₘ₂); and wherein the further illumination apparatus adheres to a first formula:

$${D}_{VM 2} = N \frac{{d}^{2}}{2 λ} \qquad Equation ( 2 )$$

wherein N is an integer.

The first distance (d_{VM1}) may adhere to a second formula:

$${D}_{VM 1} = M \frac{{d}^{2}}{2 λ} \qquad Equation ( 3 )$$

wherein M is an integer different to integer N.

The first distance (dᵥₘ₁) may be larger than the second distance (dᵥₘ₂).

An optical phase-retardation of each optical element may correspond to a difference between: first Optical Path Differences (OPD) with respect to an optical axis for each optical element of an array of optical elements at the first distance (dᵥₘ₁) from the radiation emitting device; and second Optical Path Differences (OPD2) with respect to the optical axis for each optical element of the array of optical elements at the second distance dᵥₘ₂ from the radiation emitting device, wherein the second distance adheres to the second formula.

The at least one radiation-emitting element may comprise an array of Vertical Cavity Surface Emitting Lasers (VCSEL).

According to a second aspect of the disclosure, there is provided a method of manufacturing an illumination apparatus, the method comprising: configuring an optical phase-retardation of each optical element of an array of optical elements and disposing the array at a first distance (D_{VM1}) from at least one radiation-emitting element, such that the at least one radiation-emitting element is configured to generate, in cooperation with the array, a structured light pattern comprising a regular array of dots.

Configuring an optical phase-retardation of each optical element may comprise: calculating first optical path differences (OPD1) with respect to an optical axis for each optical element of an array of optical elements at the first distance (dᵥₘ₁) from the radiation emitting device; calculating second optical path differences (OPD2) with respect to the optical axis for each optical element of the array of optical elements at a second distance dᵥₘ₂ from the radiation emitting device, wherein the second distance adheres to a first formula:

$${D}_{VM 2} = N \frac{{d}^{2}}{2 λ}$$

calculating third optical path differences (ΔOPD) between the first and second optical path differences; and transforming the third optical path differences (ΔOPD) into an optical phase-retardation of each optical element.

When each optical element comprises a microlens, transforming the third optical path differences (ΔOPD) into the optical phase-retardation of each optical element may comprise increasing a thickness of a base portion each microlens.

When each optical element comprises a microlens, transforming the third optical path differences (ΔOPD) into the optical phase-retardation of each optical element may comprise selecting a refractive index of each microlens.

When each optical element comprises a microlens, transforming the third optical path differences (ΔOPD) into the optical phase-retardation of each optical element may comprise selecting a refractive index of a portion of a substrate upon which each microlens is provided.

When each optical element comprises a metalens, transforming the third optical path differences (ΔOPD) into the optical phase-retardation of each optical element may comprise selecting dimensions of one or more pillars forming each metalens.

The optical phase-retardation of each optical element may be configured such that a pitch and/or dot size of the regular array of dots corresponds to a pitch and/or dot size of an array of dots that would be generated by a further illumination apparatus comprising: a further array of identical optical elements arranged with a same pitch (d) as the array of optical elements; the further array of identical optical elements at the second distance (dᵥₘ₂) from a further at least one radiation-emitting element configured to emit radiation with a same wavelength (λ) as radiation from the at least one radiation-emitting element, wherein the second distance (dᵥₘ₂) is different from the first distance (dᵥₘ₁), and wherein the further illumination apparatus adheres to the second formula.

The above summary is intended to be merely exemplary and non-limiting. The disclosure includes one or more corresponding aspects, embodiments or features in isolation or in various combinations whether or not specifically stated (including claimed) in that combination or in isolation. It should be understood that features defined above in accordance with any aspect of the present disclosure or below relating to any specific embodiment of the disclosure may be utilized, either alone or in combination with any other defined feature, in any other aspect or embodiment or to form a further aspect or embodiment of the disclosure.

### BRIEF DESCRIPTION OF THE DRAWINGS

These and other aspects of the present disclosure will now be described, by way of example only, with reference to the accompanying drawings, wherein:

FIG. 1 depicts a configuration of radiation-emitting elements and a microlens array, and a resultant structured light pattern exemplifying a principle of operation of prior art illumination apparatuses;

FIG. 2 depicts several structured light patterns comprising arrays of dots corresponding to different HC planes, further exemplifying a principle of operation of prior art illumination apparatuses;

FIG. 3 depicts a graph showing a relationship between a number of dots and a size of the dots of a structured light patterns produced by prior art illumination apparatuses;

FIG. 4 depicts a representation of Optical Path Differences for a configuration of a radiation-emitting element and a microlens array;

FIG. 5 depicts further representation of Optical Path Differences for configurations of radiation-emitting elements and microlens arrays arranged on different HC planes;

FIG. 6 an example of a step of calculating an Optical Path Difference in a first method of designing an illumination apparatus, according to an embodiment of the disclosure;

FIG. 7 depicts a further step in the first method of FIG. 6 of designing an illumination apparatus, according to the embodiment of the disclosure;

FIG. 8 depicts a resultant structured light pattern from an illumination apparatus designed according to the first method depicted in FIGS. 6 and 7;

FIG. 9 depicts an example of a step of calculating an Optical Path Difference in a second method of designing an illumination apparatus, according to a further embodiment of the disclosure;

FIG. 10 depicts a further step in the second method of FIG. 9 of designing an illumination apparatus, according to the further embodiment of the disclosure;

FIG. 11 depicts a resultant structured light pattern from an illumination apparatus designed according to the second method depicted in FIGS. 9 and 10;

FIG. 12 depicts an example of a step of calculating an Optical Path Difference in a third method of designing an illumination apparatus, according to a further embodiment of the disclosure;

FIG. 13 depicts a further step in the third method of FIG. 12 of designing an illumination apparatus, according to the further embodiment of the disclosure;

FIG. 14 depicts a resultant structured light pattern from an illumination apparatus designed according to the third method depicted in FIGS. 12 and 13;

FIG. 15 depicts cross sections of arrays of optical elements, wherein an optical phase-retardation of each optical element is configured according to an embodiment of the disclosure; and

FIG. 16 depicts an example of an illumination apparatus according to an embodiment of the disclosure.

### DETAILED DESCRIPTION OF THE DRAWINGS

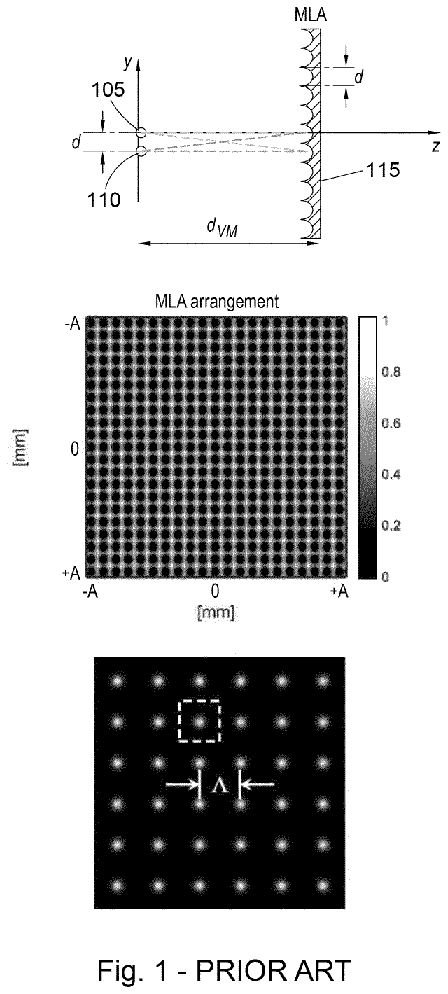

FIG. 1 depicts a configuration of radiation-emitting elements 105, 110 and a microlens array 115, and a resultant structured light pattern exemplifying a principle of operation of prior art illumination apparatuses.

A first radiation-emitting element 105 emits radiation that is incident upon the microlens array 115 to generate a dot pattern 120. That is, a single first radiation-emitting element 105 generates the entire dot pattern 120 depicted in FIG. 1.

A second radiation-emitting element 110 also emits radiation that is incident upon the microlens array 115. The second radiation-emitting element 110 is separated from the first radiation-emitting element 110 by a pitch “d”. The microlenses of the microlens array 115 are also separated by the pitch “d”. That is, a pitch of the microlens array 115 matches the pitch of the radiation-emitting elements 105, 110.

A distance dᵥₘ between the radiation-emitting elements 105, 110 and the microlens array 115 is defined by Equation 1, wherein N is an integer and A is a wavelength of radiation emitted by the radiation-emitting elements 105, 110.

In the example, if an angle between the second radiation-emitting element 110 and an optical axis ‘z’ of the microlens of the microlens array 115 in front of the second radiation-emitting element 110 is equal to a diffraction angle of the microlens array 115, a second dot pattern is generated that exactly overlaps the first dot pattern 120. As such, a plurality of radiation-emitting elements separated by a pitch corresponding to a pitch of an microlens array and at a distance from the MLA defined by Equation 1 may be used to provide a high contrast dot pattern.

That is, in the example of FIG. 1, radiation from each radiation-emitting element 105, 110 is incident upon each lens of the microlens array with substantially the same phase, such that the radiation from the lenses interferes constructively to generate the high contrast dot pattern. A precise arrangement of the distance dᵥₘ between the radiation-emitting elements 105, 110 and the microlens array 115 relative to the pitch d of the microlens array 115 and radiation-emitting elements 105, 110 is required to ensure the constructive interference occurs to generate the required high-contrast dot pattern.

Also shown in FIG. 1 is a depth profile of the microlens array 115, wherein the microlens array comprises lenses arranged with a sub-millimeter pitch. For purposes of illustration, the depth has been normalized to a range from 0 to 1, and dimensions of the square grid microlens array range from “+A” to “−A” millimeters in x and y directions.

As described above, the distance dᵥₘ is defined, in part, by integer N. Each instance of N corresponds to a plane, and may hereafter be referred to as a high contrast plane or an “HC plane”. That is, a plane at a distance of 1×dᵥₘ may be referred to a “HC1 plane”, a plane at a distance of 2×dᵥₘ may be referred to as a “HC2 plane”, and so on.

It is known that, the dot size and dot pitch of the generated dot pattern depends upon N, e.g. upon the particular HC plane.

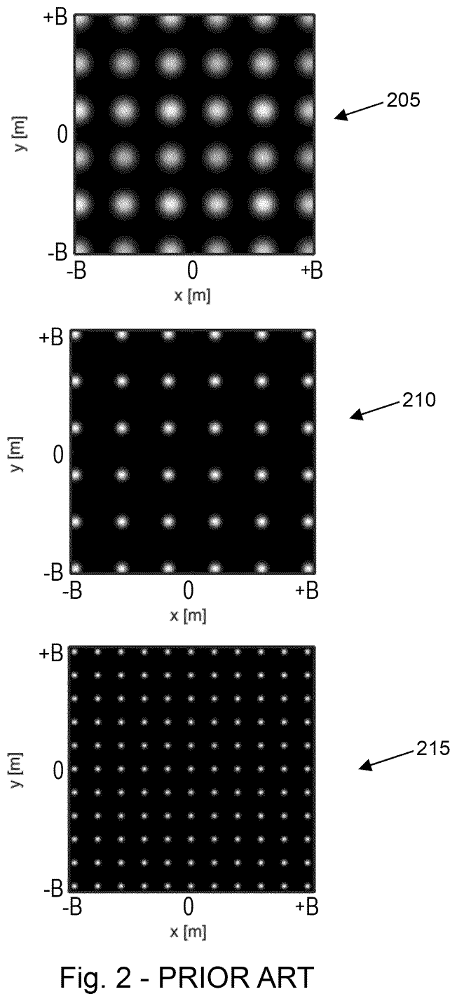

For example, FIG. 2 depicts several structured light patterns comprising arrays of dots corresponding to different HC planes, further exemplifying a principle of operation of prior art illumination apparatuses.

The examples of FIG. 2 correspond to a central portion of a dot pattern projected at a one meter distance by a square grid microlens array.

A first structured light pattern 205 comprises a regular array of dots. In this example, a gap between the microlens array and an array of radiation emitting elements is approximately 1.3 millimeters and corresponds to the HC1 plane. The first structured light pattern 205 may therefore be termed an HC1 pattern.

A second structured light pattern 210 comprises a regular array of dots. In this example, a gap between the microlens array and the array of radiation emitting elements is approximately 2.7 millimeters and corresponds to the HC2 plane. The second structured light pattern 210 may therefore be termed an HC2 pattern. The dots of the HC2 patterns are smaller than the dots of the HC1 pattern.

A third structured light pattern 210 comprises a regular array of dots. In this example, a gap between the microlens array and the array of radiation emitting elements is approximately 5.3 millimeters and corresponds to the HC4 plane. The third structured light pattern 215 may therefore be termed an HC4 pattern. The dots of the HC4 patterns are smaller and arranged with a finer pitch than the dots of the HC1 and HC2 patterns.

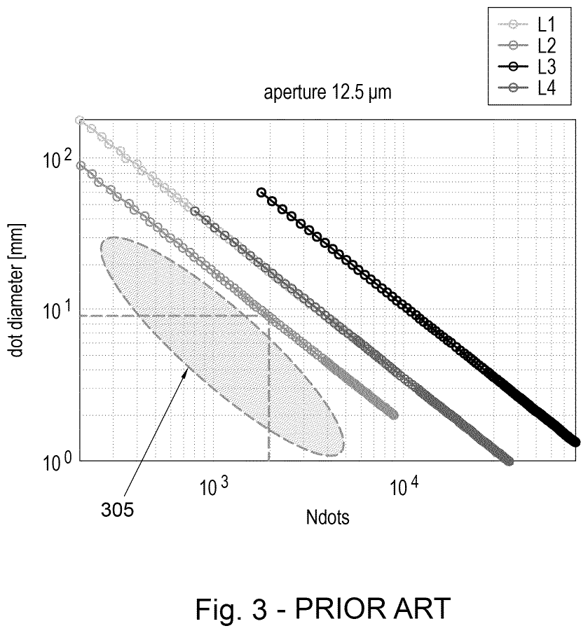

That is, the different dot sizes and pitches in the examples of FIG. 2 are due to the distances between the emitter and the microlens array, wherein in each example the distance between the emitter and the microlens array adheres to Equation 1. This principle is further explained with reference to FIG. 3.

FIG. 3 depicts a graph showing a relationship between a number of dots and a size of the dots of a structured light patterns produced by prior art illumination apparatuses.

In the example, the graph depicts an approximated dot diameter as a function of dot count within a given Field of View (FOV), which in the depicted example is a FOV of approximately 60°×50°. It will be understood that the data displayed in the graph is for purposes of example only.

Each point in the graph represents a different combination of microlens array pitch and HC plane, e.g. a different distance dᵥₘ. It can be seen that a size of the dots is approximately inversely proportional to a number of the dots within a defined FOV.

Notably, the graph also shows that, for square microlens arrays, the HC2 plane is the one that provides the lowest dot diameter for a given number of dots within the FOV.

It can be seen that structured light patterns having combinations of dot count and dot size, represented by the shaded region 305, cannot be achieved for devices that adhere to Equation 1.

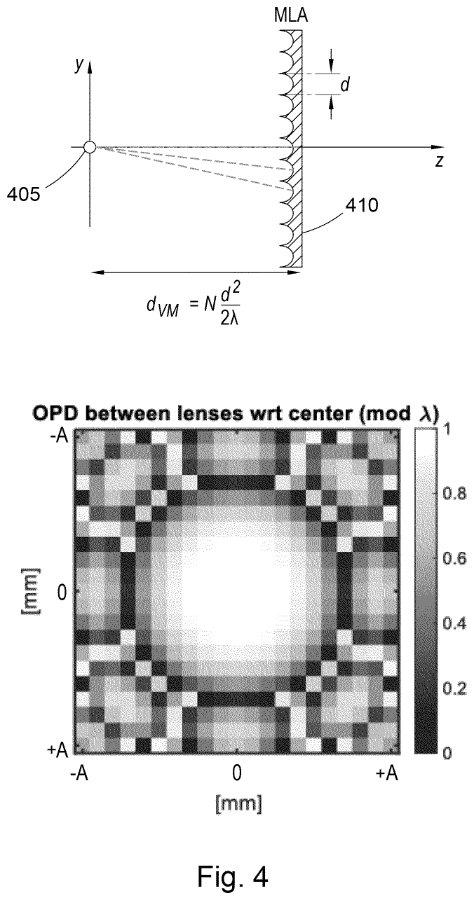

Turning now to FIG. 4, there is depicted a representation of Optical Path Differences (OPD) for a configuration of a radiation-emitting element 405 and a microlens array 410.

The radiation-emitting element 405 is at a distance dᵥₘ from the microlens array 410 and emits radiation directly towards the microlens array 410 along axis ‘z’. A distance between the radiation-emitting element 405 and each lens of the microlens array 410 can be calculated and expressed as an OPD compared to the distance on axis, dᵥₘ. The OPD is expressed as modulo of the wavelength λ. As such, 0 and 1 represent the same phase. An example of the OPD for a HC1 plane is also depicted in FIG. 4.

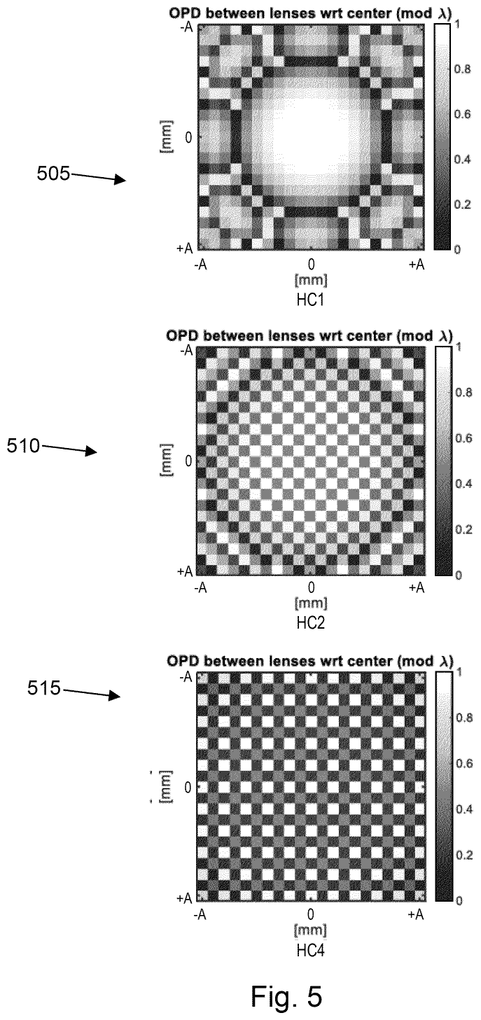

Notably, different HCN planes exhibit OPD patterns such that constructive interference happens at the output of the microlens array, forming dots in specific directions, or angles. These OPD patterns are different in each HC plane. The particular OPD pattern determines the number of dots in the dot pattern. The pattern is strictly linked to dᵥₘ. This phenomenon is depicted in FIG. 5, which shows representations of OPD for configurations of radiation-emitting elements and microlens arrays arranged on different HC planes. For purposes of example, a first OPD representation 505 corresponds to an HC1 plane, e.g. N=1, a second OPD representation 510 corresponds to a HC2 plane, and a third OPD representation 515 corresponds to an HC4 plane.

As described in more detail below, embodiments of the disclosure relate to modifying the microlens array such that, for any selected distance between the emitter and the microlens array, radiation emitted by the at least one radiation emitting element towards the microlens array experiences an OPD that produces a desired number of dots and/or dots arranged with a desired pitch.

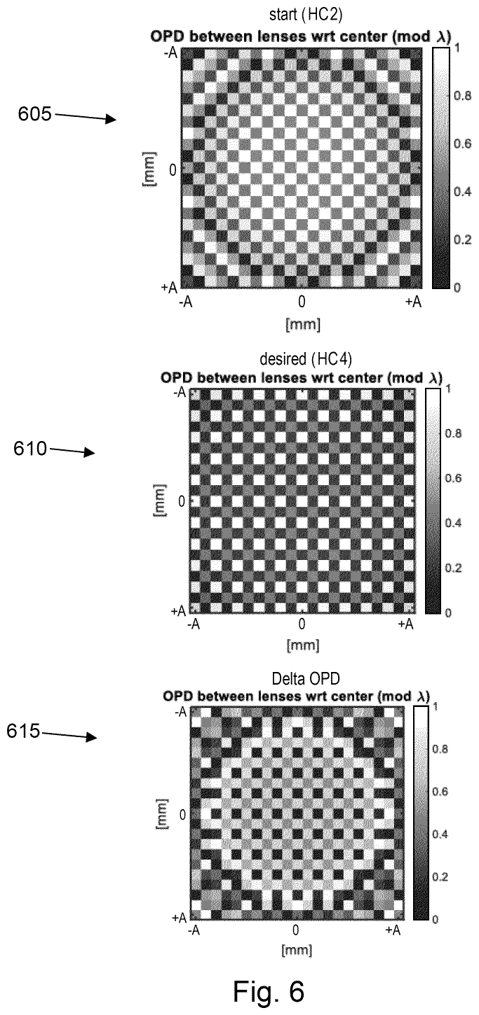

FIG. 6 depicts an example of a step of calculating an OPD in a method of designing an illumination apparatus, according to an embodiment of the disclosure.

For example, an illumination apparatus having a microlens array at a distance dᵥₘ, hereafter referred to as first distance dᵥₘ₁, from at least one radiation emitting device and configured to adhere to Equation 1 may be configured such that an HC2 pattern would normally be generated, e.g. N=2, creating first structured light pattern 205. For such an illumination apparatus, a first OPD 605 may be calculated.

However, it may be desirable that a pattern containing a number of dots generally corresponding to an HC4 pattern is generated, e.g. third structured light pattern 215, without changing the first distance dᵥₘ₁. A second OPD 610 may be calculated, wherein the second OPD 610 corresponds to a desired HC4 plane, e.g. an OPD if the distance was to be increased to a second distance dᵥₘ₂ such that N=4.

A difference between the first OPD 605 and the second OPD 610 may be calculated to produce a third OPD 615. The third optical path difference 615 may be transformed into an optical phase-retardation of each optical element, as described below in more detail.

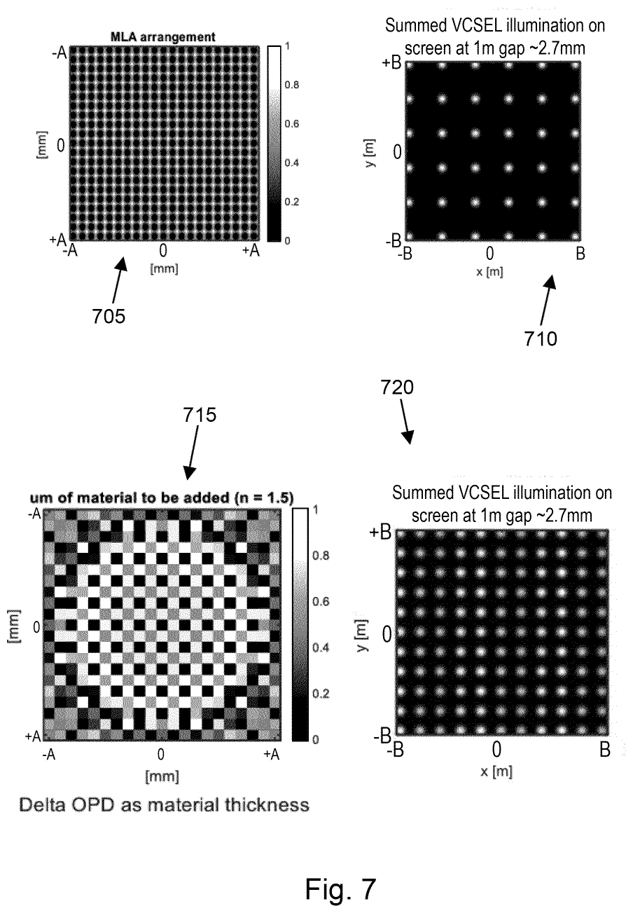

The method of FIG. 6 is depicted in more detail in FIG. 7, which depicts a process of designing the illumination apparatus.

A profile 705 of a microlens array is depicted, wherein for purposes of example the microlens array comprises lenses arranged with a sub-millimeter pitch. For purposes of example, the depth has been normalized to a range from 0 to 1.

Also depicted is a first dot pattern 710 that the microlens array may produce when disposed at the first distance dᵥₘ₁, from at least one radiation-emitting element, which in the example is a distance of approximately 2.7 millimeters. The first dot pattern 710 is an HC2 pattern.

The third OPD 615 may be transformed into an optical phase-retardation of each optical element of the microlens array. In the example of FIG. 7, the optical phase-retardation is realised by increasing a thickness of each element of the microlens array in accordance with the third OPD 615. In one example, extra material may be added to each optical element of the microlens array by modifying a base layer of individual lenses. In other examples, the optical phase-retardation of each optical element of the microlens array may be modified by adjusting a refractive index of the substrate upon which the microlens array is formed. A thickness 715 of material to be added to each optical element is depicted. By adding the thickness 715 of material to the design of each element of the microlens array having initial profile 705, a microlens array may be provided that produces second dot pattern 720 while remaining at the first distance dᵥₘ₁ from the at least one radiation emitting element.

The second dot pattern 720 comprises dots having substantially the same size as dots of the first dot pattern 710, but with a pitch that corresponds to a pitch of an HC4 pattern. Therefore, second dot pattern 720 has four times the number of dots than the first dot pattern 710.

That is, starting from an initial design for an illumination apparatus that would produce an HC2 pattern, an optical phase-retardation of each lens of the microlens array has been adjusted by adding extra material to each optical element of the microlens such that in a resultant design for the illumination apparatus, the illumination apparatus would be configured to produce a dot pattern having a pitch corresponding to an HC4 pattern. A distance between the microlens array and at least one radiation-emitting element in the initial design and the resultant design is the same.

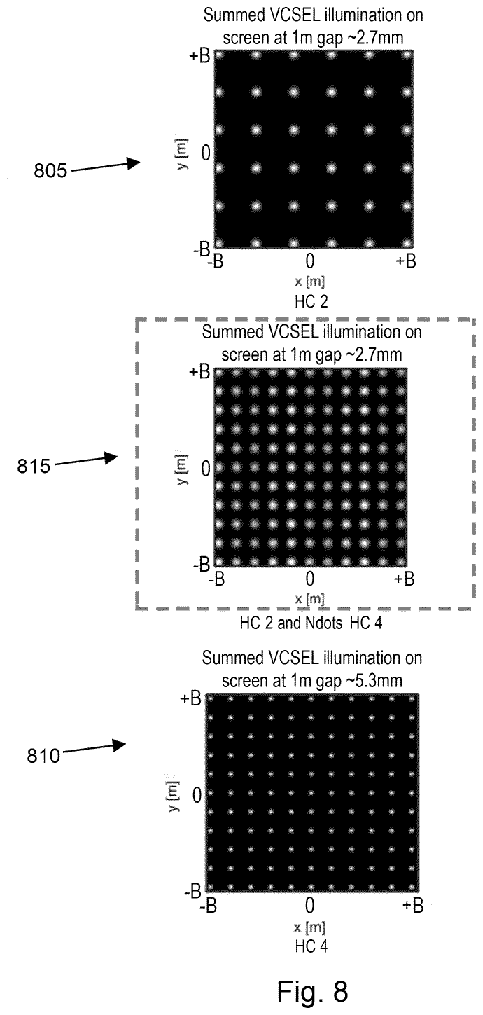

FIG. 8 depicts a resultant structured light pattern from an illumination apparatus designed according to the first method depicted in FIGS. 6 and 7.

The HC2 pattern 805 of the initial design is depicted, which in the example is based on a first distance dᵥₘ₁, of 2.7 millimeters between the microlens array and the at least one radiation-emitting element. An HC4 pattern 810 that would be generated if the first distance was increased to a second distance dᵥₘ₂ of 5.3 millimeters is also depicted, wherein the HC4 pattern has smaller dots arranged with a finer pitch.

Finally, a third pattern 815 is depicted, wherein the third pattern 815 is generated by the resultant illumination apparatus after each element of the MLA has its optical phase retardation adjusted as described above. The third pattern 815 has dots having substantially the same size as dots of the first dot pattern 810, because the dot diameter is linked to the first distance dᵥₘ₁ which has not been changed. The third pattern 815 has dots arranged with a pitch corresponding to the pitch of the HC4 pattern 810.

Advantageously, adjusting the optical phase retardation as described above enables a low-cost illumination apparatus configured to generate the third pattern 815. Alternative means to generate such a pattern may require implementation of four sections of radiation-emitting elements, or partitioning of the MLA into four sections shifted relative to one another, thereby incurring cost and increasing complexity.

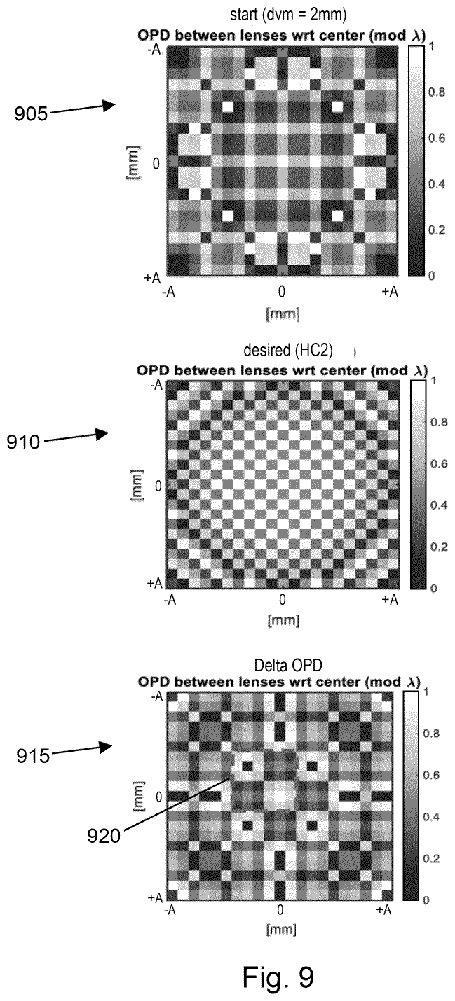

FIG. 9 depicts an example of a step of calculating an OPD in a further method of designing an illumination apparatus, according to a further embodiment of the disclosure.

For example, an illumination apparatus having a microlens array at a distance of 2 millimeters from at least one radiation emitting device. It will be appreciated that the distance of 2 millimeters is selected for purposes of example, and other distances may be selected. Notably, the distance of 2 millimeters does not conform to an HC plane, e.g. is not a distance dᵥₘ adhering to Equation 1. For such an illumination apparatus, a first OPD 905 may be calculated.

However, it may be desirable that a dot pattern generally corresponding to an HC2 pattern is generated, e.g. second structured light pattern 210, without changing the distance from 2 millimeters. A second OPD 910 may be calculated, wherein the second OPD 910 corresponds to a desired HC2 plane, e.g. an OPD if the distance was to be changed to a second distance dᵥₘ₂ such that N=2.

A difference between the first OPD 905 and the second OPD 910 may be calculated to produce a third OPD 915. The third optical path difference 915 may be transformed into an optical phase-retardation of each optical element, as described below in more detail.

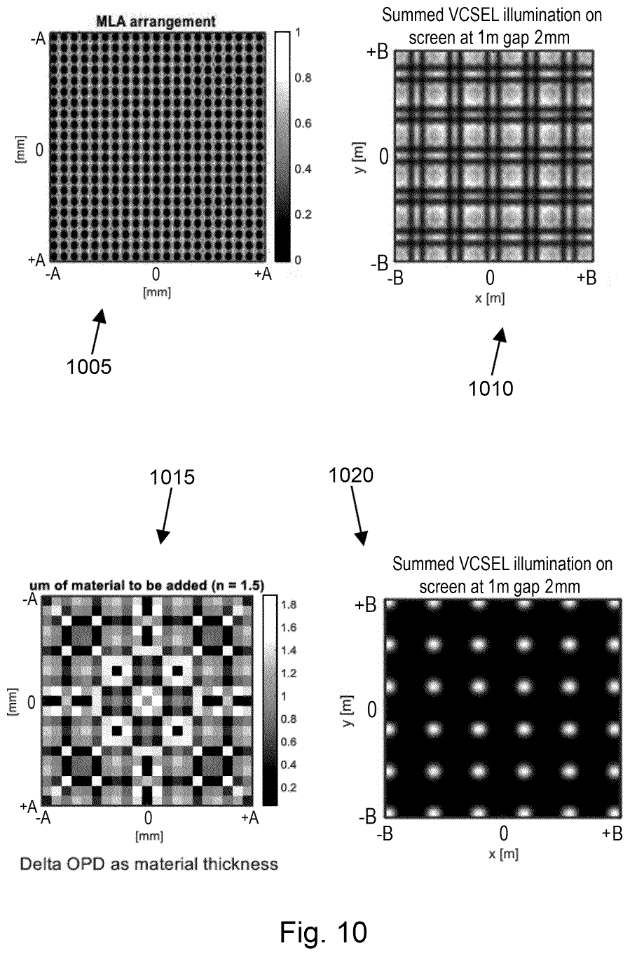

The method of FIG. 9 is depicted in more detail in FIG. 10, which depicts a process of designing the illumination apparatus.

A profile 1005 of a microlens array is depicted, wherein for purposes of example the microlens array comprises lenses arranged with a sub-millimeter. For purposes of example, the depth has been normalized to a range from 0 to 1. Also depicted is a first pattern 1010 that the microlens array may produce when disposed at a distance from a radiation-emitting element, which in the described example is a distance of 2 millimeters.

The third OPD 915 may be transformed into an optical phase-retardation of each optical element of the microlens array. In the example of FIG. 10, the optical phase-retardation is realized by increasing a thickness of each element of the microlens array in accordance with the third OPD 915. In one example, extra material may be added to each optical element of the microlens array by modifying a base layer of individual lenses. In other examples, the optical phase-retardation of each optical element of the microlens array may be modified by adjusting a refractive index of the substrate upon which the microlens array is formed. A thickness 1015 of material to be added to each optical element is depicted. By adding the thickness 1015 of material to the design of each element of the microlens array having initial profile 705, a microlens array may be provided that produces a dot pattern 1020 while remaining at the 2 millimeter distance from the radiation emitting element.

The second dot pattern 720 comprises dots having a pitch that corresponds to a pitch of an HC2 pattern.

That is, starting from an initial design for an illumination apparatus that would not produce a dot pattern, an optical phase-retardation of each lens of the microlens array has been adjusted by adding extra material to each optical element of the microlens such that in a resultant design for the illumination apparatus, the illumination apparatus would be configured to produce a dot pattern having a pitch corresponding to an HC2 pattern. A distance between the microlens array and the radiation-emitting element in the initial design and the resultant design is the same.

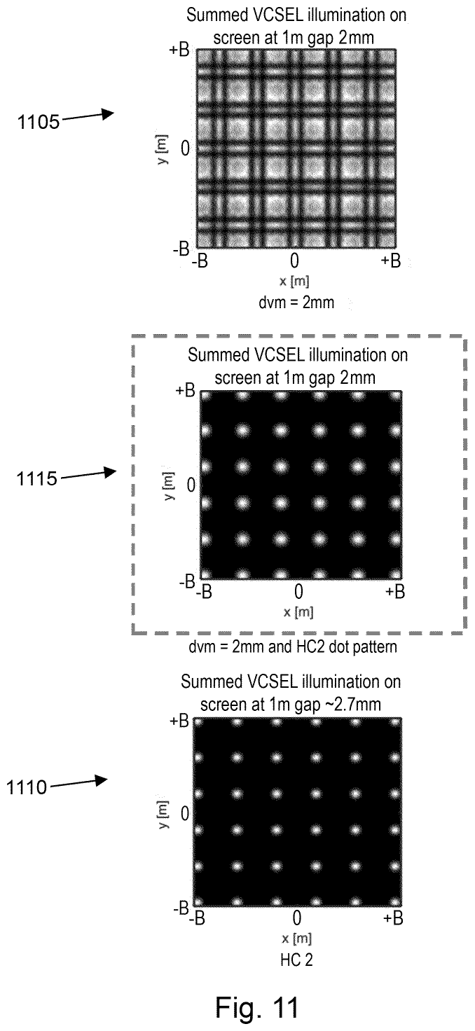

FIG. 11 depicts a resultant structured light pattern from an illumination apparatus designed according to the first method depicted in FIGS. 9 and 10.

The pattern 1105 of the initial design is depicted, which in the example is based on a distance 2 millimeters between the microlens array and the radiation-emitting element. An HC2 pattern 1110 that would be generated if the distance was increased to a distance dᵥₘ₂ of approximately 2.7 millimeters is also depicted.

Finally, a third pattern 1115 is depicted, wherein the third pattern 1115 is generated by the resultant illumination apparatus after each element of the MLA has its optical phase retardation adjusted as described above. The third pattern 1115 has dots arranged with a pitch corresponding to the pitch of the HC2 pattern 1110.

Notably, the third pattern 1115 has dots having a slightly larger size than the dots of the HC2 pattern 1110, because the dot diameter is linked to the distance 2 millimeters, which has not been changed.

The example of FIGS. 9 to 11 is provided for an illumination apparatus comprising a single radiation-emitting element. In embodiments of the illumination apparatus comprising a plurality of radiation-emitting elements, a central portion 920 of the third OPD 915 may be arrayed in a periodic manner.

Advantageously, adjusting the optical phase retardation as described above enables a low-cost illumination apparatus configured to generate the dot pattern 1020 with an arbitrary distance between the at least one radiation-emitting element and the microlens array.

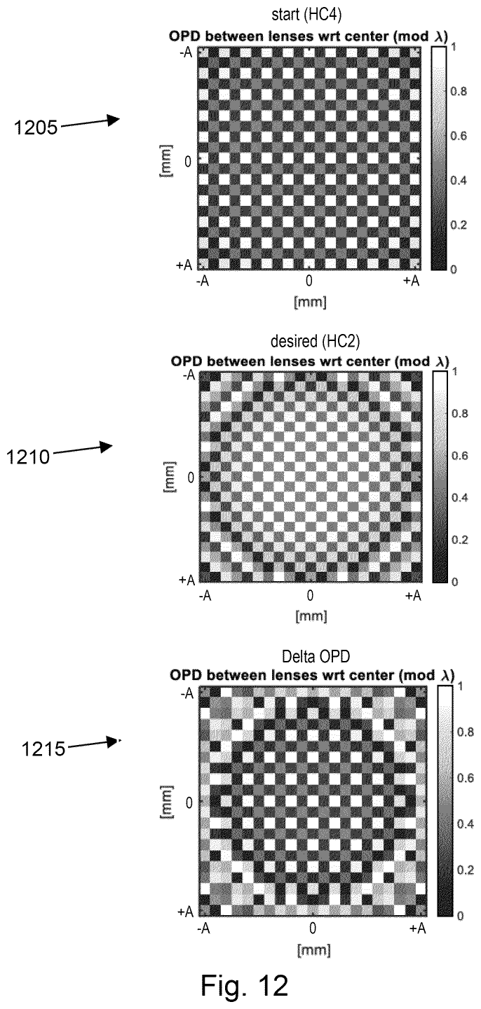

FIG. 12 depicts an example of a step of calculating an OPD in a further method of designing an illumination apparatus, according to a further embodiment of the disclosure.

For example, an illumination apparatus having a microlens array at a distance dᵥₘ, hereafter referred to as first distance dᵥₘ₁, from at least one radiation emitting device and configured to adhere to Equation 1 may be configured such that an HC4 pattern would normally be generated, e.g. N=4, creating first structured light pattern 205. For such an illumination apparatus, a first OPD 1205 may be calculated.

However, it may be desirable that a pattern generally corresponding to an HC2 pattern is generated, e.g. second structured light pattern 210, without changing the first distance dᵥₘ₁. A second OPD 1210 may be calculated, wherein the second OPD 1210 corresponds to a desired HC2 plane, e.g. an OPD if the distance was to be increased to a second distance dᵥₘ₂ such that N=2.

A difference between the first OPD 1205 and the second OPD 1210 may be calculated to produce a third OPD 1215. The third optical path difference 1215 may be transformed into an optical phase-retardation of each optical element, as described below in more detail.

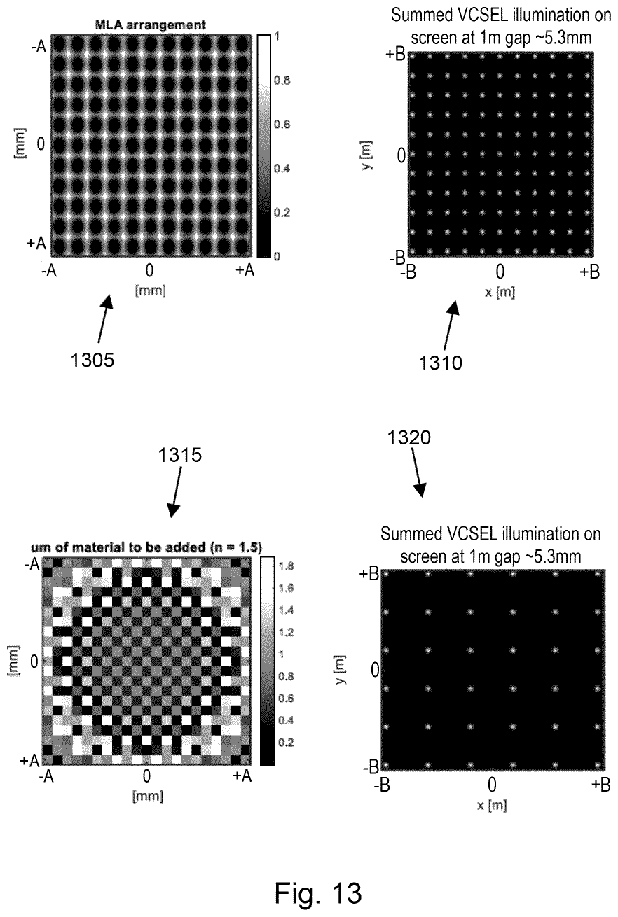

The method of FIG. 12 is depicted in more detail in FIG. 13, which depicts a process of designing the illumination apparatus.

A profile 1305 of a microlens array is depicted, wherein for purposes of example the microlens array comprises lenses arranged with a sub-millimeter pitch. For purposes of example, the depth has been normalized to a range from 0 to 1. Also depicted is a first dot pattern 1310 that the microlens array may produce when disposed at the first distance dᵥₘ₁, from at least one radiation-emitting element, which in the example is a distance of approximately 5.3 millimeters. The first dot pattern 1310 is an HC4 pattern.

The third OPD 1215 may be transformed into an optical phase-retardation of each optical element of the microlens array. In the example of FIG. 13, the optical phase-retardation is realized by increasing a thickness of each element of the microlens array in accordance with the third OPD 1315. In one example, extra material may be added to each optical element of the microlens array by modifying a base layer of individual lenses. In other examples, the optical phase-retardation of each optical element of the microlens array may be modified by adjusting a refractive index of the substrate upon which the microlens array is formed. A thickness 1315 of material to be added to each optical element is depicted. By adding the thickness 1315 of material to the design of each element of the microlens array having initial profile 1305, a microlens array may be provided that produces second dot pattern 1320 while remaining at the first distance dᵥₘ₁ from the at least one radiation emitting element.

The second dot pattern 1320 comprises dots having substantially the same size as dots of the first dot pattern 1310, but with a pitch that corresponds to a pitch of an HC2 pattern. Therefore, second dot pattern 1320 has a quarter of the number of dots of the first dot pattern 1310.

That is, starting from an initial design for an illumination apparatus that would produce an HC4 pattern, an optical phase-retardation of each lens of the microlens array has been adjusted by adding extra material to each optical element of the microlens such that in a resultant design for the illumination apparatus, the illumination apparatus would be configured to produce a dot pattern having a pitch corresponding to an HC2 pattern. A distance between the microlens array and at least one radiation-emitting element in the initial design and the resultant design is the same.

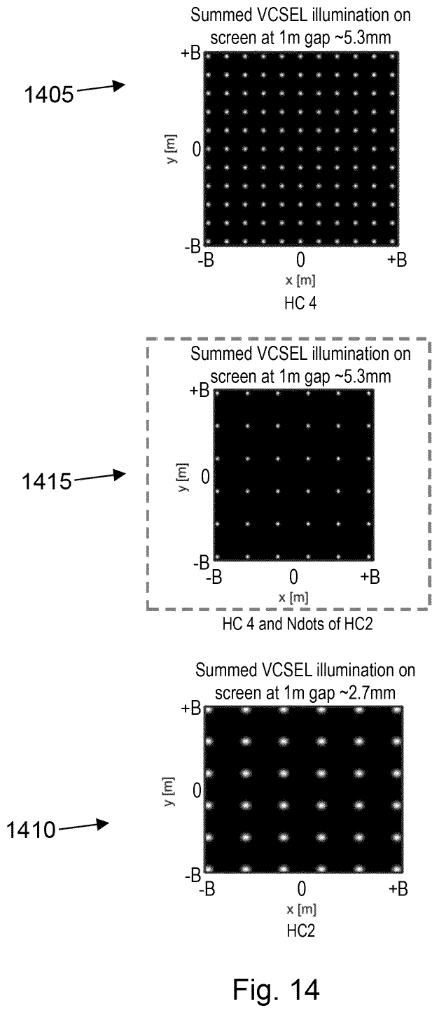

FIG. 14 depicts a resultant structured light pattern from an illumination apparatus designed according to the first method depicted in FIGS. 12 and 13.

The HC4 pattern 1405 of the initial design is depicted, which in the example is based on a first distance dᵥₘ₁ of approximately 5.3 millimeters between the microlens array and the at least one radiation-emitting element. An HC2 pattern 1410 that would be generated if the first distance was decreased to a second distance dᵥₘ₂ of approximately 2.6 millimeters is also depicted, wherein the HC2 pattern has smaller dots arranged with a finer pitch.

Finally, a third pattern 1415 is depicted, wherein the third pattern 1415 is generated by the resultant illumination apparatus after each element of the MLA has its optical phase retardation adjusted as described above. The third pattern 1415 has dots having substantially the same size as dots of the first dot pattern 1410, because the dot diameter is linked to the first distance dᵥₘ₁ which has not been changed. The third pattern 1415 has dots arranged with a pitch corresponding to the pitch of the HC2 pattern 1410.

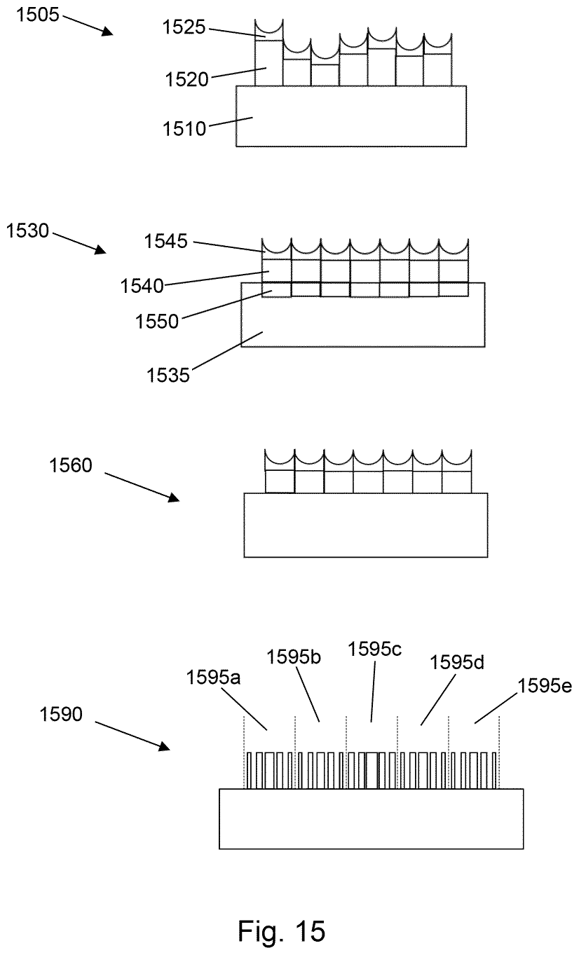

FIG. 15 depicts cross sections of arrays of optical elements, wherein an optical phase-retardation of each optical element is configured according to an embodiment of the disclosure.

In a first example, a first array of optical elements 1505 is a microlens array comprising a plurality of microlenses. For purposes of illustration only, the first array of optical elements 1505 is depicted as having seven microlenses in cross section, although it will be appreciated that in practical implementations a microlens array may have more or less than seven microlenses in cross section.

The first array of optical elements 1505 comprises a substrate 1510. Each optical element is formed on the substrate 1510, and each optical element comprises a base portion 1520 and a lens portion 1525. It can be seen that the base portion 1520 of each optical element may differ in thickness from other base portions 1520 of other optical elements formed on the substrate 1510.

As such, the optical phase-retardation each microlens may be selected by selecting a thickness of each respective base portion 1520. With reference to the embodiments described above, by adding a particular thickness of material to the base portion of each optical element of a microlens array, a microlens array may be provided that effectively produces a desired OPD relative to at least one radiation-emitting element.

In a second example, a second array of optical elements 1530 is a microlens array comprising a plurality of microlenses. Again, for purposes of illustration only, the second array of optical elements 1530 is depicted as having seven microlenses in cross section, although it will be appreciated that in practical implementations a microlens array may have more or less than seven microlenses in cross section.

The second array of optical elements 1530 comprises a substrate 1535. Each optical element is formed on the substrate 1535, and each optical element comprises a base portion 1540 and a lens portion 1545. Each optical element is formed over a respective portion 1550 of the substrate, wherein a refractive index of the respective portion 1550 of the substrate upon which each microlens is provided may be selected to define the optical phase-retardation each optical element. Each respective portion may be formed as a layer, e.g. a thin film, deposited or otherwise formed on the substrate 1535.

In a third example, a third array of optical elements 1560 is a microlens array comprising a plurality of microlenses. In this example, each optical element is formed from a material having a refractive index selected to define the optical phase-retardation each optical element. That is, different lenses in the third array may be formed from different materials, wherein the different material exhibit different refractive indices.

Furthermore, in yet further embodiments, the techniques in any or all of the first, second and/or third examples may be combined.

In a fourth example, a fourth array of optical elements 1590 is an array of metalenses 1595a-e. For purposes of illustration only, the fourth array of optical elements 1590 is depicted as having five metalenses in cross section, although it will be appreciated that in practical implementations an array or metalenses may have more or less than five metalenses in cross section.

In the fourth example, the optical phase-retardation of each metalens is defined by dimensions and/or shape and/or orientation of one or more pillars, fins, mesas or fin like pillars forming each metalens. For example, in case of cylindrical pillars, the optical phase-retardation of each metalens may be defined by dimensions, such as a diameter of each pillar. In case of fin-like pillars, the optical phase-retardation of each metalens may be defined by a relative rotation of the pillars. Generally, features of each metalens may be selected to implement a desired phase retardation.

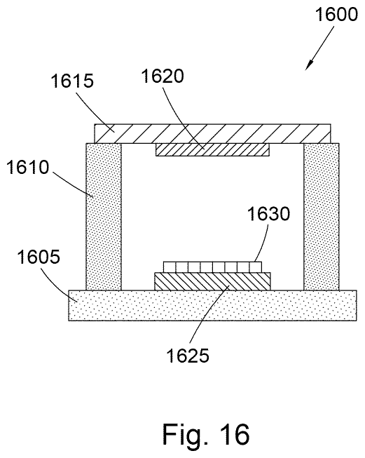

FIG. 16 depicts an example of an illumination apparatus 1600 according to an embodiment of the disclosure. The example illumination apparatus 1600 comprises a first substrate 1605. The substrate 1605 may, for example, be a printed circuit board (PCB) substrate or a silicon substrate.

The illumination apparatus 1600 also comprises a spacer 1610. The spacer 1610 is mounted on the first substrate 1605. The spacer 1610 holds a second substrate 1615 at a defined distance from the first substrate 1605. The second substrate may be, for example, a glass substrate. The second substrate 1615 is transparent to wavelengths of radiation emitted by the plurality of radiation-emitting elements 1630.

An array of optical elements 1620 is provided on the second substrate 1615. The array of optical elements 1620 may, for example, be a microlens array 1620. In other examples, the array of optical elements 1620 may be a metalens array. The array of optical elements 1620 may, for example, be formed by a process of replication, nano-imprinting, or by otherwise depositing or adhering the array 1620 to the second substrate 1615.

A third substrate 1625 is mounted on the first substrate 1605. A plurality of radiation-emitting elements 1630 is formed on the third substrate 1625. In some embodiments, the plurality of radiation-emitting elements 1630 are VCSELs. The plurality of radiation-emitting elements 1630 may be arranged as a regular array of radiation-emitting elements 1630, e.g. arranged on a grid pattern.

The plurality of radiation-emitting elements 1630 are configured to generate, in cooperation with the array of optical elements 1620, a structured light pattern. An optical phase-retardation of each optical element 1620 of radiation emitted by the plurality of radiation-emitting elements 1630 is configured such that the structured light pattern comprises a regular array of dots.

Although the disclosure has been described in terms of preferred embodiments as set forth above, it should be understood that these embodiments are illustrative only and that the claims are not limited to those embodiments. Those skilled in the art will be able to make modifications and alternatives in view of the disclosure, which are contemplated as falling within the scope of the appended claims. Each feature disclosed or illustrated in the present specification may be incorporated in any embodiments, whether alone or in any appropriate combination with any other feature disclosed or illustrated herein.

### REF NUMERALS

| | |
|---|---|
| 105 | first radiation-emitting element |
| 110 | second radiation-emitting element |
| 115 | microlens array |
| 205 | first structured light pattern |
| 210 | second structured light pattern |
| 215 | third structured light pattern |
| 305 | shaded region |
| 405 | radiation-emitting element |
| 410 | microlens array |
| 505 | first OPD representation |
| 510 | second OPD representation |
| 515 | third OPD representation |
| 605 | first OPD |
| 610 | second OPD |
| 615 | third OPD |
| 705 | initial profile |
| 710 | first dot pattern |
| 715 | thickness |
| 720 | second dot pattern |
| 805 | HC2 pattern |
| 810 | HC4 pattern |
| 815 | third pattern |
| 905 | first OPD |
| 910 | second OPD |
| 915 | third OPD |
| 920 | central portion |
| 1005 | profile |
| 1010 | first pattern |
| 1015 | thickness |
| 1020 | dot pattern |
| 1105 | pattern |
| 1110 | HC2 pattern |
| 1115 | third pattern |
| 1205 | first OPD |
| 1210 | second OPD |
| 1215 | third OPD |
| 1305 | profile |
| 1310 | first dot pattern |
| 1315 | third OPD |
| 1320 | second dot pattern |
| 1405 | HC4 pattern |
| 1410 | HC2 pattern |
| 1415 | third pattern |
| 1505 | optical elements |
| 1510 | substrate |
| 1520 | base portion |
| 1525 | lens portion |
| 1530 | optical elements |
| 1535 | substrate |
| 1540 | base portion |
| 1545 | lens portion |
| 1550 | respective portion |
| 1560 | optical elements |
| 1590 | optical elements |
| 1595a | metalens |
| 1595b | metalens |
| 1595c | metalens |
| 1595d | metalens |
| 1595a | metalens |
| 1595e | metalens |
| 1595f | metalens |
| 1600 | illumination apparatus |
| 1605 | first substrate |
| 1610 | spacer |
| 1615 | second substrate |
| 1620 | optical elements |
| 1625 | third substrate |
| 1630 | radiation-emitting elements |

1. An illumination apparatus comprising:
an array of optical elements, each comprising a microlens; and
at least one radiation-emitting element configured to generate, in cooperation with the array, a structured light pattern,
wherein an optical phase-retardation of each optical element of radiation emitted by the at least one radiation-emitting element is configured such that the structured light pattern comprises a regular array of dots.

2. The illumination apparatus of claim 1, wherein the array of optical elements comprises a plurality of optical elements having a different optical phase-retardation to one another.

3. The illumination apparatus of claim 1, wherein each optical element comprises a microlens.

4. The illumination apparatus of claim 3, wherein the optical phase-retardation each microlens is defined, at least in part, by:
a thickness of a base portion each microlens; a refractive index of each microlens; and/or
a refractive index of a portion of a substrate upon which each microlens is provided.

5. The illumination apparatus of claim 1, wherein each optical element comprises a metalens.

6. The illumination apparatus of claim 5, wherein the optical phase-retardation of each metalens is defined by at least one of:
dimensions of one or more pillars forming each metalens; and/or
a relative rotation and/or shape of one or more mesas or fin-like structures forming each metalens.

7. The illumination apparatus of claim 1, wherein the array is disposed at a first distance (dᵥₘ₁) from the at least one radiation-emitting element and wherein the optical phase-retardation of each optical element is configured such that the structured light pattern comprises a regular array of dots having a pitch and/or dot size that would be provided by a further illumination apparatus comprising:
a further array of identical optical elements arranged with a same pitch as the array of optical elements,
the further array of identical optical elements at a second distance (dᵥₘ₂) from a further at least one radiation-emitting element configured to emit radiation with a same wavelength (λ) as radiation from the at least one radiation-emitting element,
wherein the second distance (dᵥₘ₂) is different from the first distance (dᵥₘ₂), and
wherein the further illumination apparatus adheres to a first formula:
$${D}_{VM 2} = N \frac{{d}^{2}}{2 λ}$$
wherein N is an integer.

8. The illumination apparatus claim 7, wherein the first distance (dᵥₘ₁) adheres to a second formula:
$${D}_{VM 1} = M \frac{{d}^{2}}{2 λ}$$
wherein M is an integer different to the integer N.

9. The illumination apparatus of claim 7, wherein the first distance (dᵥₘ₁) is larger than the second distance (dᵥₘ₂).

10. The illumination apparatus of claim 7, wherein an optical phase-retardation of each optical element corresponds to a difference between:
first Optical Path Differences (OPD) with respect to an optical axis for each optical element of an array of optical elements at the first distance (dᵥₘ₁) from the radiation-emitting element; and
second Optical Path Differences (OPD2) with respect to the optical axis for each optical element of the array of optical elements at the second distance dᵥₘ₂ from the radiation-emitting element, wherein the second distance adheres to the second formula.

11. The illumination apparatus of claim 1, wherein the at least one radiation-emitting element comprises an array of Vertical Cavity Surface Emitting Lasers (VCSEL).

12. A method of manufacturing an illumination apparatus, the method comprising:
configuring an optical phase-retardation of each optical element of an array of optical elements and disposing the array at a first distance (Dᵥₘ₁) from at least one radiation-emitting element, such that the at least one radiation-emitting element is configured to generate, in cooperation with the array, a structured light pattern comprising a regular array of dots.

13. The method of claim 12, wherein configuring an optical phase-retardation of each optical element comprises:
calculating first optical path differences (OPD1) with respect to an optical axis for each optical element of an array of optical elements at the first distance (dᵥₘ₁) from the radiation-emitting element;
calculating second optical path differences (OPD2) with respect to the optical axis for each optical element of the array of optical elements at a second distance dᵥₘ₂ from the radiation-emitting element, wherein the second distance adheres to a first formula:
$${D}_{VM 2} = N \frac{{d}^{2}}{2 λ} ,$$
calculating third optical path differences (ΔOPD) between the first and second optical path differences; and
transforming the third optical path differences (ΔOPD) into an optical phase-retardation of each optical element.

14. The method of claim 13, wherein transforming the third optical path differences (OPD) into the optical phase-retardation of each optical element comprises:
when each optical element comprises a microlens, at least one of:
increasing a thickness of a base portion each microlens; selecting a refractive index of each microlens; and/or selecting a refractive index of a portion of a substrate upon which each microlens is provided; or
when each optical element comprises a metalens, selecting dimensions of one or more pillars forming each metalens and/or a relative rotation and/or shape of one or more mesas or fin-like structures forming each metalens.

15. The method of claim 14, wherein the optical phase-retardation of each optical element is configured such that a pitch and/or dot size of the regular array of dots corresponds to a pitch and/or dot size of an array of dots that would be generated by a further illumination apparatus comprising:
a further array of identical optical elements arranged with a same pitch (d) as the array of optical elements,
the further array of identical optical elements at the second distance (dᵥₘ₂) from a further at least one radiation-emitting element configured to emit radiation with a same wavelength (λ) as radiation from the at least one radiation-emitting element, wherein the second distance (dᵥₘ₂) is different from the first distance (dᵥₘ₁), and wherein the further illumination apparatus adheres to the second formula.
